(19) United States
(12) Patent Application Publication
(10) Pub. No.: US 2015/0317947 A1
(43) Pub. Date: Nov. 5, 2015

(54) DISPLAY APPARATUS, DISPLAY METHOD, AND PROGRAM

(71) Applicant: SEIKO EPSON CORPORATION, Tokyo (JP)

(72) Inventor: Takeshi WADA, Shiojiri-shi (JP)

(21) Appl. No.: 14/702,550

(22) Filed: May 1, 2015

(30) Foreign Application Priority Data
May 2, 2014 (JP) 2014-095030

(51) Int. Cl. G09G 5/10; G06T 1/60; G09G 5/18

(52) U.S. Cl. CPC G09G 5/10; G09G 5/18; G06T 1/60

(57) ABSTRACT

When an area to be rewritten includes a first area including a character and a second area including an image object, a control unit outputs, to a controller, a display update instruction and information indicating the second area. Upon acquisition of the instruction and the information indicating the second area, first, the controller updates the first area and the second area by a first method. Next, the controller updates the second area by a second method that requires a longer updating time than the first method.

### BACKGROUND

1. Technical Field

The present invention relates to a display apparatus, a display method, and a program.

2. Related Art

Technologies for updating a binary image area and a grayscale image area include a technology disclosed in JP-A-2009-251615, for example. The technology disclosed in JP-A-2009-251615 relates to updating of the display of an electrophoretic display apparatus, where the display is updated through a plurality of frame periods, not a single frame period. For example, a grayscale image area is updated during the period from the 1^{st} frame to the 8^{th} frame, and a binary image area is updated during the period from the 4^{th} frame to the 6^{th} frame.

According to the technology disclosed in JP-A-2009-251615, even when the displayed image includes both the binary image area and the grayscale image area, the updating of the binary image area can be started before completion of the updating of the grayscale image area. However, the updating of the binary image area is started from the 4^{th} frame with a delay from the updating of the grayscale image area, and the user has an impression that the updating of the binary image area is slow.

### SUMMARY

An advantage of some aspects of the invention is to increase the perceived speed of updating of the display in the case of simultaneously displaying areas that are different in the number of gray levels that can be expressed therein.

One aspect of the invention provides a display apparatus including an updating unit that updates a first area by a first method, and updates a second area by a second method, the first area being at least a portion of a display area of a display unit, and the second area being a portion of the display area. The number of gray levels that can be expressed by the first method is N, where N denotes an integer no less than 2 and less than M, and the number of gray levels that can be expressed by the second method is M, where M denotes an integer no less than 3. The speed of the updating by the first method is greater than the speed of the updating by the second method.

Note that “the speed of the updating” above is used in terms of the time required for changing the gray level value of a pixel in a display area from the gray level value corresponding to a first image to the gray level value corresponding to a second image when the image displayed in the display area is changed from the first image to the second image. In other words, the time required for updating the first image to the second image is shorter in the first area than in the second area.

According to this aspect of the invention, in the case of simultaneously displaying areas that are different in the number of the gray levels that can be expressed therein, the perceived speed of updating the display is increased.

It is preferable that the second area is an area including an image object, a file corresponding to a screen that is to be displayed on the display area includes information indicating the second area, and the updating unit specifies the second area based on the information.

This configuration makes it easy to specify the second area.

It is preferable that, when the second area is provided in a plurality, the plurality of second areas are merged into a single second area.

This configuration makes it possible to update the plurality of second areas at a time, thereby reducing the power consumption.

It is preferable that, when the second area is provided in a plurality, the updating unit sequentially updates the plurality of second areas.

This configuration reduces the size of the area to be updated by the second method, compared to the configuration of merging the plurality of second areas into a single area.

It is preferable that the updating unit updates the plurality of second areas in descending order of size.

This configuration increases the perceived speed of updating of the display, because a larger second area is updated earlier.

It is preferable that, when the second area is provided in a plurality, and some of the plurality of second areas overlap each other, the second areas overlapping each other are merged into a single second area.

This configuration makes it possible to update the plurality of second areas at a time, thereby reducing the power consumption.

Another aspect of the invention provides a display method including: updating a first area by a first method, and updating a second area by a second method, the first area being at least a portion of a display area of a display unit, and the second area being a portion of the display area. The number of gray levels that can be expressed by the first method is N, where N denotes an integer no less than 2 and less than M. The number of gray levels that can be expressed by the second method is M, where M denotes an integer no less than 3. The speed of the updating by the first method is greater than the speed of the updating by the second method.

According to this aspect of the invention, in the case of simultaneously displaying areas that are different in the number of the gray levels that can be expressed therein, the perceived speed of updating the display is increased.

Yet another aspect of the invention provides a program that causes a computer to perform updating of a first area by a first method, and updating of a second area by a second method, the first area being at least a portion of a display area of a display unit, and the second area being a portion of the display area. The number of gray levels that can be expressed by the first method is N, where N denotes an integer no less than 2 and less than M. The number of gray levels that can be expressed by the second method is M, where M denotes an integer no less than 3. The speed of the updating by the first method is greater than the speed of the updating by the second method.

According to this aspect of the invention, in the case of simultaneously displaying areas that are different in the number of the gray levels that can be expressed therein, the perceived speed of updating the display is increased.

### BRIEF DESCRIPTION OF THE DRAWINGS

The invention will be described with reference to the accompanying drawings, wherein like numbers reference like elements.

FIG. 1 is a diagram showing a display apparatus 10 according to an embodiment of the invention.

FIG. 2 is a diagram showing a hardware configuration of the display apparatus 10.

FIG. 3 is a diagram showing a relationship between a voltage applied to a pixel and a gray level value of the pixel.

FIGS. 4A and 4B are diagrams showing an example of the contents of a first LUT 1061.

FIGS. 5A and 5B are diagrams showing an example of the contents of a second LUT 1062.

FIG. 6 is a diagram showing a change in the gray level value in the case of a first method.

FIG. 7 is a diagram showing a change in the gray level value in the case of a second method.

FIG. 8 is a functional block diagram of the display apparatus 10.

FIG. 9 is a flowchart showing operation performed by a control unit 100.

FIGS. 10A to 10D are diagrams showing an example of a screen displayed by a display unit 107.

FIGS. 11A and 11B are diagrams illustrating a modification example.

FIGS. 12A and 12B are diagrams illustrating a modification example.

### DESCRIPTION OF EXEMPLARY EMBODIMENTS

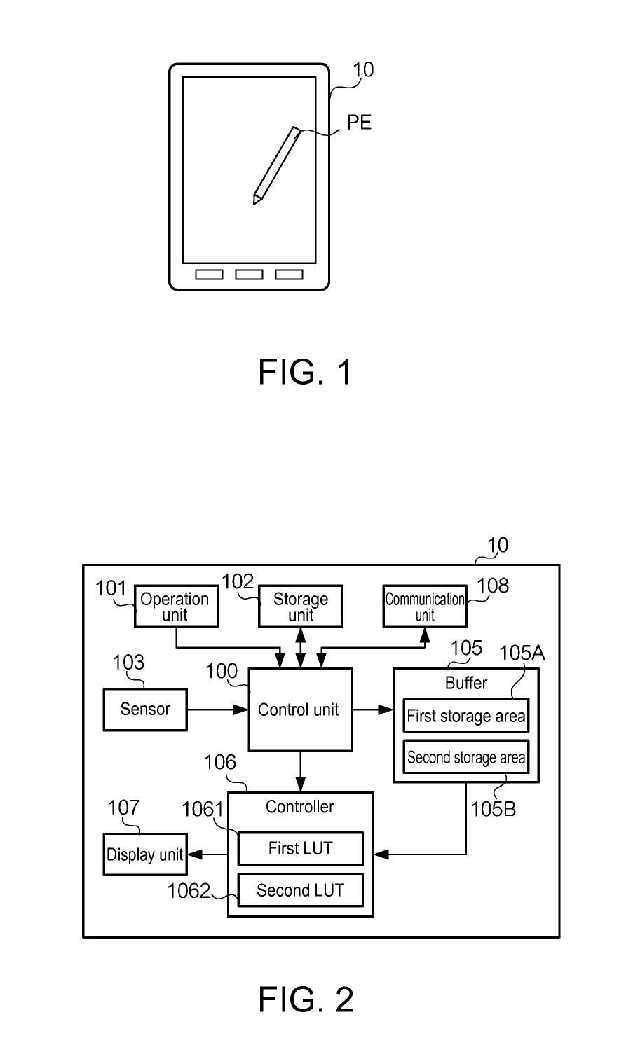

FIG. 1 is a diagram showing a display apparatus 10 according to an embodiment of the invention. The display apparatus 10 includes an electrophoretic display device, and has the function of displaying a document corresponding to a document file. One example of document formats that the display apparatus 10 can process is Portable Document Format (PDF). However, the document format is not limited to PDF, and may be another format.

The display apparatus 10 includes a sensor that detects, at predetermined intervals, the coordinates of a stylus pen PE touching a display surface where an image is displayed. When the user moves the stylus pen PE along the display surface, the sensor detects the coordinates of the contact point on the display surface touched by the stylus pen PE. The display apparatus 10 specifies an instruction from the user based on the detected coordinates and on a user interface image that is being displayed, and performs operation according to the instruction from the user.

Configuration of Display Apparatus 10

FIG. 2 shows a hardware configuration of the display apparatus 10. A display unit 107 has electronic paper using electrophoretic technology. The electronic paper has pixels arrayed in a plurality of rows and columns, and displays images with multiple gray levels (i.e., grayscale). The electronic paper has a plurality of microcapsules each enclosing negatively-charged white electrophoretic particles and positively-charged black electrophoretic particles. The microcapsules are sandwiched between a transparent common electrode, which is located on the display surface side, and pixel electrodes, which are located on the rear side, one for each pixel. The common electrode is maintained at a fixed potential. When a positive voltage is applied to the pixel electrodes with the common electrode being fixed at the constant potential, the positively-charged black electrophoretic particles move toward the display surface. When a negative voltage is applied to the pixel electrodes with the common electrode being fixed at the constant potential, the negatively-charged white electrophoretic particles move toward the display surface. The display unit 107 is an exemplary display device that holds the image displayed even when power is not supplied, that is, an exemplary display device provided with a display area having memory. Note that the display unit 107 may be electronic paper using a quick-response liquid-powder display (QR-LPD®) technology. Also note that the colors of the electrophoretic particles are not limited to white and black, and may be other colors such as read and blue.

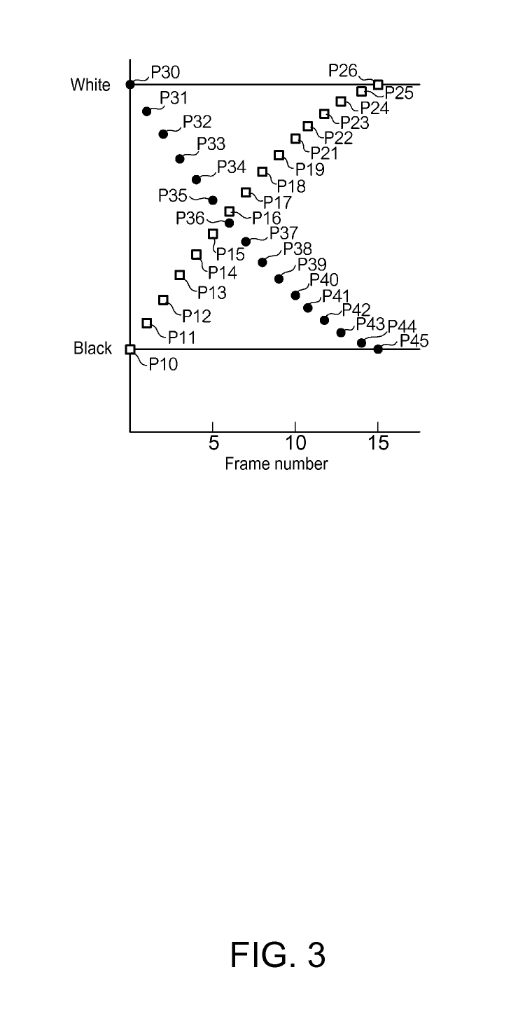

FIG. 3 is a diagram showing the relationship between the voltage applied to the electrophoretic layer of a pixel of the display unit 107 and the gray level value of the pixel after the application of the voltage. In FIG. 3, the horizontal axis shows the number of frames for which the voltage is applied, and the vertical axis shows the gray level value of the pixel. Note that “frame” is a unit of time for which the voltage is applied, and the length thereof in the present embodiment is determined in advance. In the display unit 107, the minimum gray level value corresponds to black, and the maximum gray level value corresponds to white.

For example, assume a case of applying a voltage to the electrophoretic layer of a pixel in order to cause the pixel to change the gray level value thereof from the minimum gray level value to the maximum gray level value. The initial state before the voltage application, in which the gray level of the pixel is black, is represented by point P10. From this point, when a predetermined first voltage (e.g., −15 V) is applied for one frame period to the electrophoretic layer of the pixel, the white electrophoretic particles move toward the display surface, and the gray level of the pixel becomes slightly brighter, which is represented by the transition to point P11. When the first voltage is applied for another one frame period to the electrophoretic layer of the pixel, the gray level of the pixel becomes even brighter, which is represented by the transition to point P12. Then, the gray level of the pixel sequentially changes from point P13 to point P26 while the first voltage is being applied to the electrophoretic layer of the pixel in this way. The point P26 corresponds to the maximum gray level value, which expresses white. In this example, the gray level of the pixel gradually changes from black to white while the first voltage is being applied throughout 15 frame periods.

Next, assume a case of applying a voltage to the electrophoretic layer of a pixel in order to cause the pixel to change the gray level value thereof from the maximum gray level value to the minimum gray level value. The initial state before the voltage application, in which the gray level of the pixel is white, is represented by point P30. From the state represented by the point P30, when a predetermined second voltage (e.g., +15 V) is applied for one frame period to the electrophoretic layer of the pixel, the black electrophoretic particles move toward the display surface, and the gray level of the pixel becomes slightly darker, which is represented by the transition to point P31. When the second voltage is applied for another one frame period to the electrophoretic layer of the pixel, the gray level of the pixel becomes even darker, which is represented by the transition to point P32. Then, the gray level of the pixel sequentially changes from point P33 to point P45 while the second voltage is being applied to the electrophoretic layer of the pixel in this way. The point P45 corresponds to the minimum gray level value, which expresses black. In this example, the gray level of the pixel gradually changes from white to black while the second voltage is being applied throughout 15 frame periods.

As shown in FIG. 3, regarding the gray level of each pixel of the display unit 107, the course of transition from white to black and the course of transition from black to white are different. For example, when the electrophoretic layer of a pixel having the minimum gray level value is applied with the first voltage six times, the gray level of the pixel changes to the state represented by the point P16. However, when the electrophoretic layer of a pixel in the state represented by the point P16 is applied with the second voltage six times, the gray level does not change in the order of P15, P14, P13, P12, P11, and P10, and does not change back to the state with the minimum gray level value represented by the point P10. For this reason, in the case of displaying an intermediate gray level in the present embodiment, first, the first voltage is applied for 15 frame periods so that the gray level of the pixel changes to white, and then the second voltage is applied the number of times that corresponds to the gray level to be displayed. In the case of rewriting one intermediate gray level with another intermediate gray level, first, the second voltage is applied so that the gray level of the pixel changes to black, then the first voltage is applied throughout 15 frame periods so that the gray level of the pixel changes to white, and finally the second voltage is applied the number of times that corresponds to the gray level to be displayed.

A sensor 103 is a sensor detecting the coordinates of the tip of the stylus pen PE and the pen pressure. Note that the stylus pen PE and the sensor 103 in the present embodiment may be realized with commonly known elements such as the position indicator and position detecting apparatus disclosed in JP-A-2010-117943 for example. The sensor 103 detects, at regular intervals, the coordinates of the tip of the stylus pen PE on the display area of the display unit 107, and the pressure (pen pressure) acting on the tip of the stylus pen PE. The sensor 103 outputs a pair of first data and second data to the control unit 100. The first data indicates the detected coordinates, and the second data indicates the detected pressure.

A buffer 105 includes a first storage area 105A and a second storage area 105B. The first storage area 105A is an area for storing the data of a screen to be displayed by the display unit 107. The first storage area 105A has a plurality of storage segments, one for each pixel of the display unit 107. Data indicating the gray level value of a pixel is written by the control unit 100 into the storage segment corresponding to the pixel. The second storage area 105B is an area for storing the data of a screen that was displayed by the display unit 107 before the rewriting of the screen. The second storage area 105B has a plurality of storage segments, one for each pixel of the display unit 107, and each storage segment stores the gray level value of the corresponding pixel. Data indicating the gray level value of a pixel is written by the control unit 100 into the storage segment corresponding to the pixel.

A controller 106 is a circuit for driving the display unit 107. The controller 106 in the present embodiment is provided with, as methods of driving the display unit 107, a first method for expressing two gray levels after the rewriting, and a second method for expressing 16 gray levels after the rewriting. The controller 106 switches between the first method and the second method according to the contents of the area to be rewritten. The controller 106 has look up tables (LUT) used for driving according to either the first method or the second method. LUT is a table for storing information specifying the voltage to be applied in each frame period. The controller 106 has a first LUT 1061 corresponding to the first method and a second LUT 1062 corresponding to the second method.

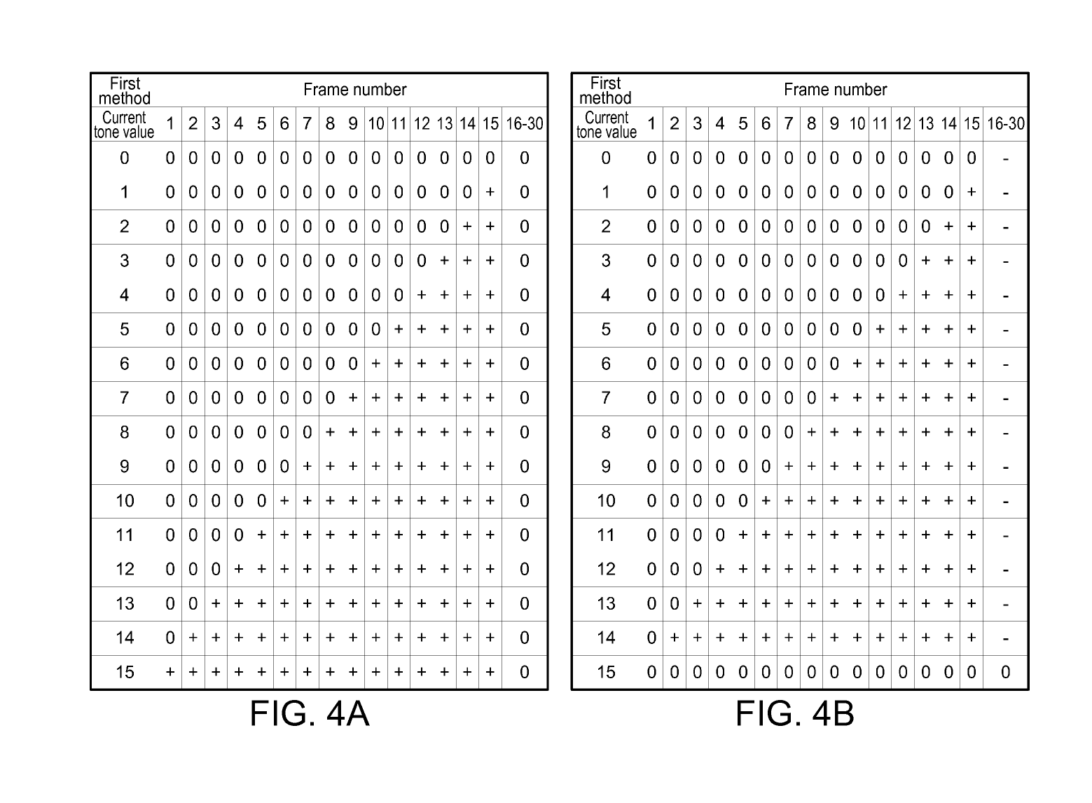

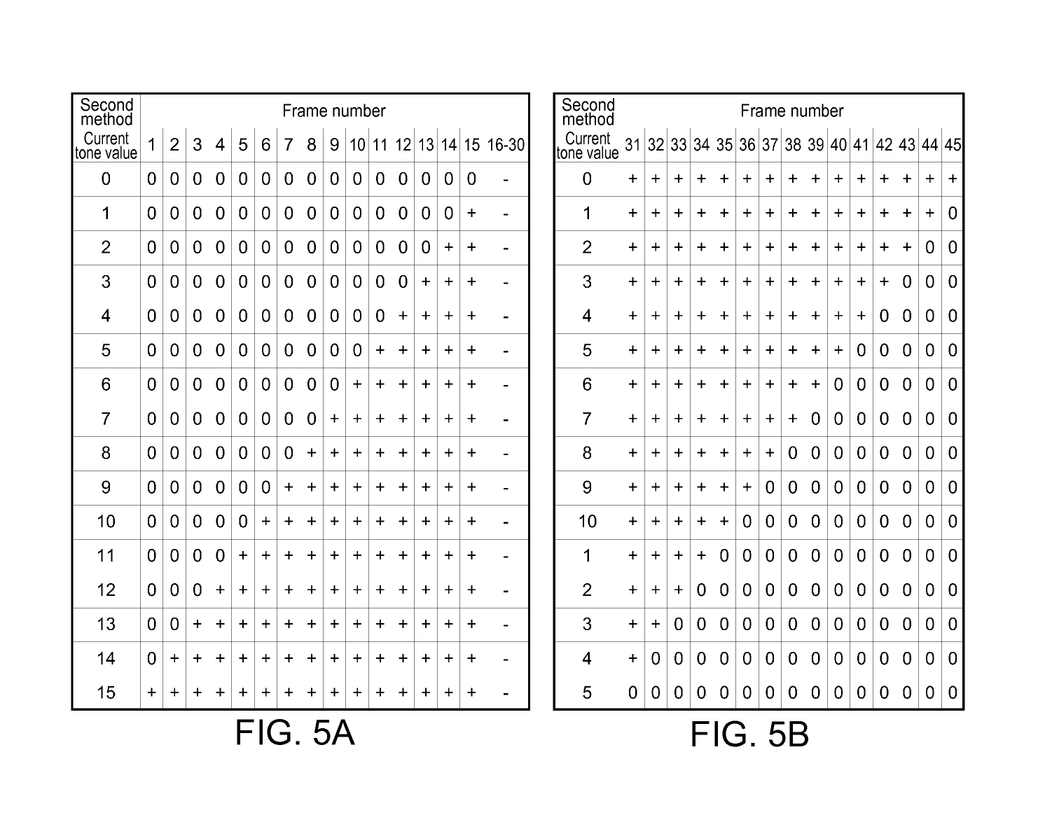

FIGS. 4A and 4B are diagrams showing an example of the contents of the first LUT 1061, and FIG. 5A and FIG. 5B are diagrams showing an example of the contents of the second LUT 1062. In these tables, each of the values 0 to 15 shown in the columns of “current gray level value” and “next gray level value” indicates the gray level value of the pixel. Also, in these tables, “+” represents that the voltage applied to the electrophoretic layer of the pixel during one frame period is a positive voltage (+15 V), and “−” represents that the voltage applied to the electrophoretic layer of the pixel during one frame period is a negative voltage (−15 V). “0” in the columns of frame numbers represents that the voltage applied to the electrophoretic layer of the pixel is maintained at the same potential as the common electrode.

When driving a pixel, the controller 106 acquires the data stored in the buffer 105, and based on the acquired data and the LUTs, the controller 106 applies the first voltage (e.g., −15 V), the second voltage (e.g., +15 V), or a voltage for discharging (0 V) to the electrophoretic layer of the pixel during a predetermined number of frame periods. The pattern of the values of the voltage to be applied to the electrophoretic layer of the pixel throughout a plurality of frame periods in order to change the gray level value of the pixel varies depending on the gray level value of the pixel before the rewriting and the gray level value of the pixel to be expressed next. It can be said that the pattern of the values of the voltage to be applied to the electrophoretic layer of the pixel represents the temporal change of the voltage to be applied. In this meaning, the pattern of the values of the voltage to be applied is referred to as “driving waveform” in the following description.

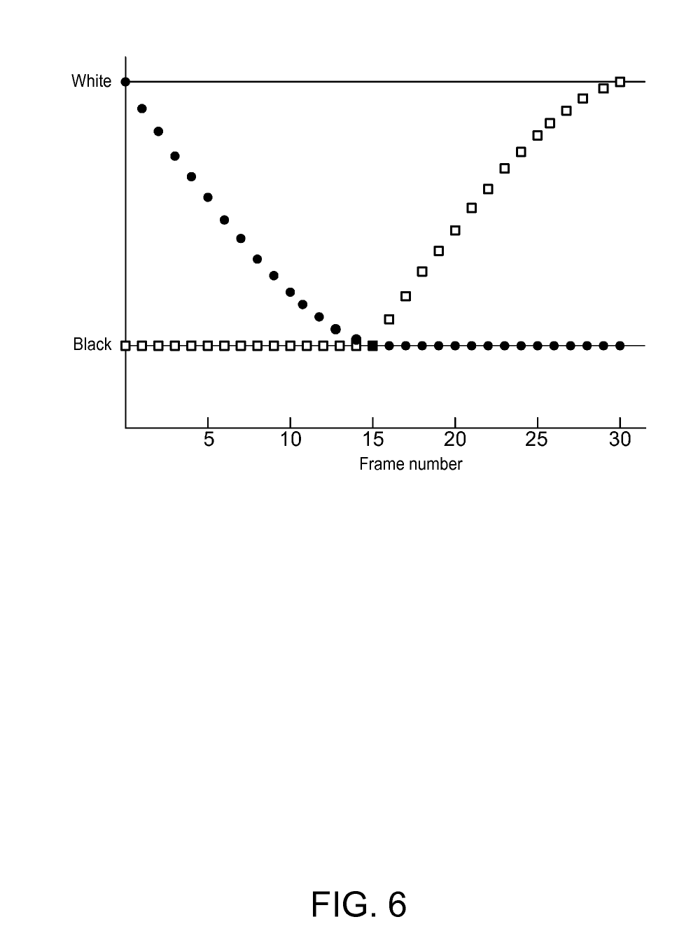

FIG. 6 is a diagram showing an example of the change in the gray level value of a pixel in the case where the gray level value of the pixel is changed to the minimum gray level value or to the maximum gray level value by the first method according to the present embodiment. In FIG. 6, the horizontal axis shows the number of frames and the vertical axis shows the gray level value of the pixel.

When changing the gray level value of a pixel by the first method, if the data stored in the first storage area 105A is not binarized data, the controller 106 first binarizes the data acquired from the first storage area 105A. Specifically, when the value of the data acquired from the first storage area 105A is from 0 to 7, the controller 106 determines the value of the acquired data to be 0, and when the value of the acquired data is from 8 to 15, the controller 106 determines the value to be 15.

When the value of the binarized data is 0, the controller 106 applies a voltage to the electrophoretic layer of the pixel by referring to the table shown in FIG. 4A. For example, with respect to a given pixel, when the value of the data stored in the second storage area 105B is 15 and the value of the binarized data is 0, the controller 106 refers to the row corresponding to the current gray level value “15” in the table shown in FIG. 4A, and applies the positive voltage during the period from the 1^{st} frame to the 15^{th} frame, and discharges the pixel during the period from the 16^{th} frame to the 30^{th} frame. Consequently, as represented by “” in FIG. 6, the gray level value of the pixel gradually decreases during the period from the 1^{st} frame to the 15^{th} frame, and the gray level value is maintained at the minimum value during the period from the 16^{th} frame.

When the value of the binarized data is 15, the controller 106 applies a voltage to the electrophoretic layer of the pixel by referring to the table shown in FIG. 4B. For example, when the value of the data stored in the second storage area 105B is 0, and the value of the binarized data is 15, the controller 106 refers to the row corresponding to the current gray level value “0” in the table shown in FIG. 4B, and discharges the pixel during the period from the 1^{st} frame to the 15th frame, and applies the negative voltage to the pixel during the period from the 16th frame to the 30th frame. Consequently, as represented by “□” in FIG. 6, the gray level value of the pixel is maintained at the minimum value during the period from the 1^{st} frame to the 15^{th} frame, and the gray level value is gradually increased during the period from the 16^{th} frame to the 30^{th} frame.

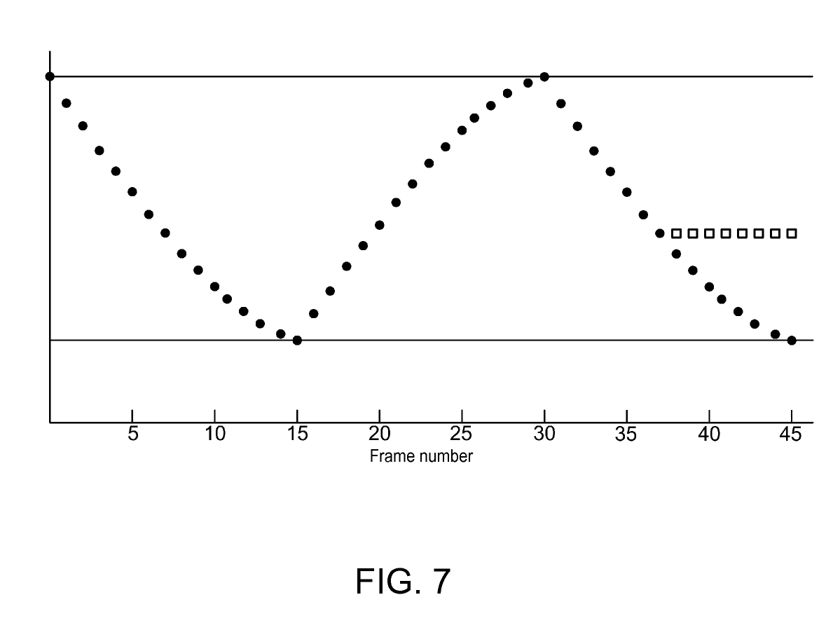

FIG. 7 is a diagram showing an example of the change in the gray level value of a pixel in the case where the gray level value of the pixel is written by using the second method according to the present embodiment. In FIG. 7, the horizontal axis shows the number of frames and the vertical axis shows the gray level value of the pixel.

When rewriting the gray level value of a pixel by the second method, the controller 106 first acquires data from the first storage area 105A and the second storage area 105B. During the period from the 1^{st} frame to the 30^{th} frame, the controller 106 refers to the table shown in FIG. 5A to apply a voltage to the electrophoretic layer of the pixel. During the period from the 31^{st} frame to the 45^{th} frame, the controller 106 refers to the table shown in FIG. 5B to apply a voltage to the electrophoretic layer of the pixel.

For example, with respect to a given pixel, when the value of the data stored in the second storage area 105B is 15 and the value of the data stored in the first storage area 105A is 0, in other words, when rewriting the gray level of the pixel from white to black, the controller 106 refers to the row corresponding to the current gray level value “15” in the table shown in FIG. 5A, and applies the positive voltage to the electrophoretic layer of the pixel during the period from the 1^{st} frame to the 15^{th} frame, and applies the negative voltage to the electrophoretic layer of the pixel during the period from the 16^{th} frame to the 30^{th} frame. With respect to the period from the 31^{st} frame to the 45^{th} frame, the controller 106 refers to the row corresponding to the next gray level value “0” in the table shown in FIG. 5B, and applies the positive voltage to the electrophoretic layer of the pixel. Consequently, as represented by “” in FIG. 7, the gray level value of the pixel gradually decreases during the period from the 1^{st} frame to the 15^{th} frame, the gray level value of the pixel gradually increases during the period from the 16^{th} frame to the 30^{th} frame, and then the gray level value of the pixel gradually decreases during the period from the 31^{st} frame to the 45^{th} frame.

Also, for example, with respect to a given pixel, when the value of the data stored in the second storage area 105B is 15 and the value of the data stored in the first storage area 105A is 7, in other words, when rewriting the gray level of the pixel from white to an intermediate gray level, the controller 106 refers to the row corresponding to the current gray level value “15” in the table shown in FIG. 5A, and applies the positive voltage to the electrophoretic layer of the pixel during the period from the 1^{st} frame to the 15^{th} frame, and applies the negative voltage to the electrophoretic layer of the pixel during the period from the 16^{th} frame to the 30^{th} frame. The controller 106 also refers to the row corresponding to the next gray level value “7” in the table shown in FIG. 5B, and applies the positive voltage to the electrophoretic layer of the pixel during the period from the 31^{st} frame to the 37^{th} frame, and discharges the pixel during the period from the 38^{th} frame to the 45^{th} frame. Consequently, as shown in FIG. 7, during the period until the 37^{th} frame, the gray level of the pixel changes in the same manner as in the case of rewriting the gray level of the pixel from white to black, and during the period from the 38^{th} period, the gray level is maintained at the intermediate gray level as represented by “□”.

When the driving of a pixel by the first method is compared with the driving of a pixel by the second method, as can be seen from the driving waveform shown in FIG. 6 and FIG. 7, the number of the frames required for changing the gray level value by the first method is smaller than by the second method, and accordingly the screen is rewritten more quickly by the first method than by the second method.

A storage unit 102 has a non-volatile memory, and stores a document file. The storage unit 102 also stores an application program A1 (hereinafter, “first application A1”) for displaying a document corresponding to the document file.

An operation unit 101 has a plurality of buttons used for operating the display apparatus 10. A communication unit 108 is a communication interface performing wireless communication. The communication unit 108 performs communication according to a communication standard for a wireless local area network (LAN), and transmits information to another apparatus, or receives information transmitted by another apparatus.

The control unit 100 is a microcomputer including a central processing unit (CPU), a read only memory (ROM), and a random access memory (RAM). When the CPU reads a program stored in the ROM and executes the read program by using the RAM as a work area, the operating system in the display apparatus 10 runs, and allows execution of application programs. In a display apparatus 10 in which the operating system is running, various functions are achieved by application programs. For example, execution of the first application A1 by the control unit 100 allows for the displaying of the document corresponding to the document file stored in the storage unit 102. In the present embodiment, in a first area including characters, the characters are displayed in black (i.e., the minimum gray level value) when the background is white, and are displayed in white (i.e., the maximum gray level value) when the background is black. In the present embodiment, in a second area including image objects (pictures, or figures created by using a computer, etc.), which are objects other than characters, the image objects are displayed with more than two gray levels. In the present embodiment, the image objects in the second area are displayed with 16 gray levels.

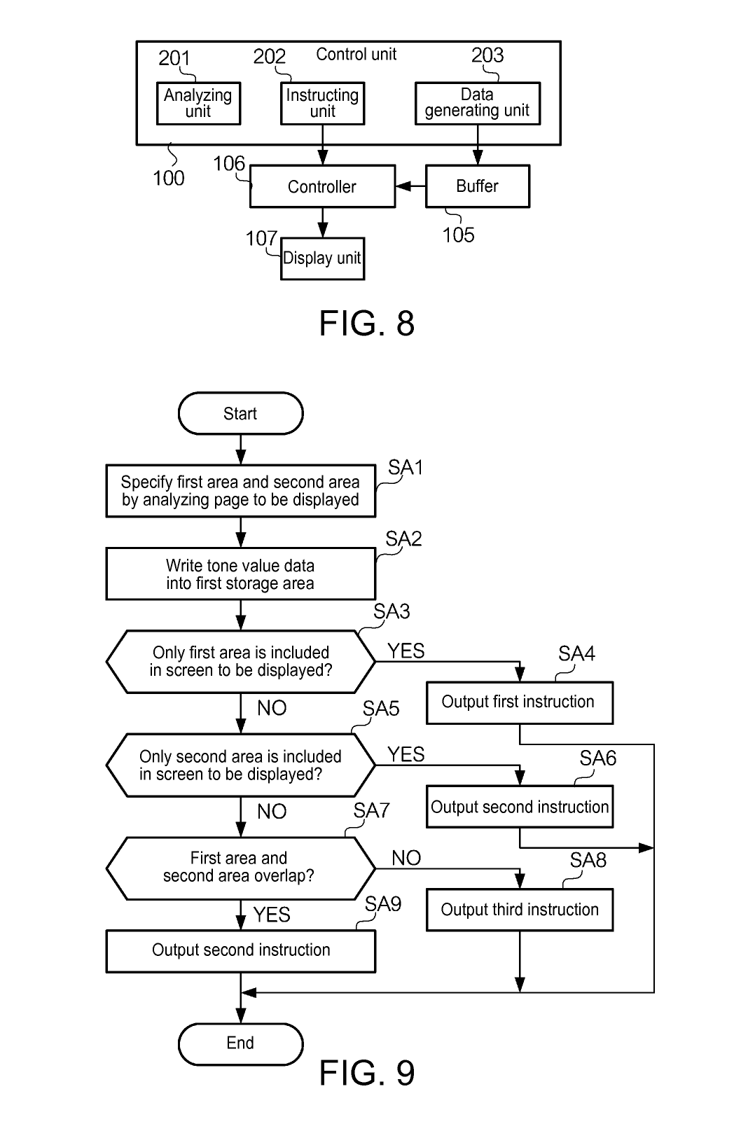

FIG. 8 is a diagram showing a functional configuration according to an embodiment of the invention.

An analyzing unit 201 analyzes a document file, specifies, within a page to be displayed of the document, a rectangular area including a character string object (hereinafter referred to as “first area”), and a rectangular area including an image object, and specifies two diagonally-opposite vertices of each rectangular area. Although the first area and the second area in the present embodiment are specified as rectangular areas, the areas may have another shape such as a circular shape.

An instructing unit 202 is a functional block for controlling the controller 106. The instructing unit 202 outputs, to the controller 106, an instruction indicating a method to be adopted for updating the display by the display unit 107. The instructing unit 202 outputs first to third instructions. When the page to be displayed includes only the first area, the instructing unit 202 outputs the first instruction to drive the display unit 107 by the first method. When the page to be displayed includes only the second area, the instructing unit 202 outputs the second instruction to drive the display unit 107 by the second method. When the page to be displayed includes both the first area and the second area, the instructing unit 202 outputs the third instruction to first drive the display unit 107 by the first method and then drive the display unit 107 by the second method. The controller 106 updates display by the display unit 107 according to the instruction output by the instructing unit 202. Since the display by the display unit 107 is updated by the instructing unit 202 and the controller 106, the instructing unit 202 and the controller 106 serve as an updating unit that updates the display by the display unit 107.

A data generation unit 203 rasterizes the screen to be displayed by the display unit 107, based on the data of the page to be displayed, and writes the data indicating the gray level value (gray level value data) of each pixel into the first storage area 105A of the buffer 105.

Exemplary Operation of Embodiment

Next, a description is given to exemplary operation of the present embodiment with reference to the flowchart shown in FIG. 9.

When the user of the display apparatus 10 performs an operation for opening a document file stored in the storage unit 102, the control unit 100 reads the document file from the storage unit 102. The control unit 100 copies the data stored in the first storage area 105A to the second storage area 105B.

Next, the control unit 100 specifies the page to be displayed from the document corresponding to the document file, and specifies the first area and the second area by analyzing the specified page (Step SA1). When the file format of the document file is PDF, the control unit 100 can easily specify the second area by analyzing the contents of the file, because the file includes information indicating the second area. Upon specifying the first area and the second area, the control unit 100 rasterizes the screen to be displayed by the display unit 107 based on the data of the page to be displayed, and writes the data indicating the gray level value (gray level value data) of each pixel into the first storage area 105A (Step SA2). Note that when an image object included in the document file is characters, this object is regarded as the second area.

Specifically, in the case where the number of the gray levels that can be expressed in the area to be rewritten is 16, the control unit 100, when performing rasterizing with respect to the first area, determines the values in the gray level value data of the pixels constituting the background of the characters to be the maximum gray level value (15), and determines the values in the gray level value data of the pixels constituting the characters to be the minimum gray level value (0). With respect to the second area, the control unit 100 performs color reduction processing on the image object, thereby setting the values in the gray level value data of the pixels constituting the object to be any value within the range from the minimum gray level value to the maximum gray level value.

Exemplary Operation for Rewriting an Area Including only Characters

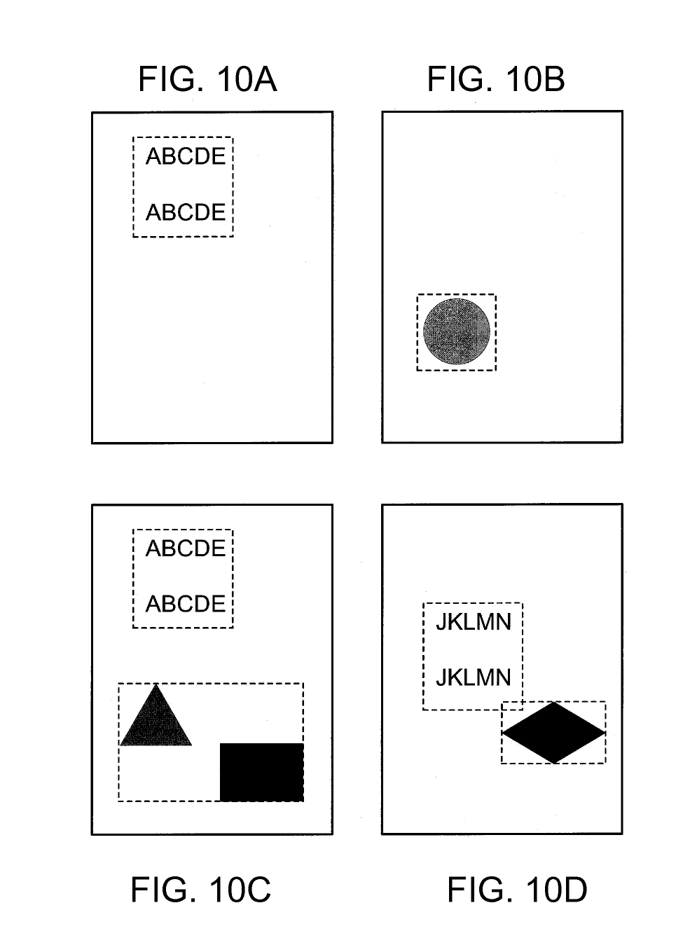

For example, when the area to be rewritten includes only characters as shown in FIG. 10A, in other words, when the area to be displayed has only the first area (indicated by the dotted line), the control unit 100 determines the values in the gray level value data of the pixels constituting the characters to be the minimum gray level value and writes such gray level value data into the first storage area 105A, and determines the values in the gray level value data of the pixels constituting the background to be the maximum gray level value and writes such gray level value data into the first storage area 105A.

Upon completion of the writing of the gray level value data into the first storage area 105A, the control unit 100 selects a method of driving the display unit 107 according to the contents of the area to be rewritten. Here, when the area to be written incudes only the first area as shown in FIG. 10A (YES at Step SA3), the control unit 100 outputs, to the controller 106, the first instruction, which is the instruction for driving the entire screen by the first method (Step SA4). Upon acquisition of the first instruction, the controller 106 drives the display unit 107 by the first method according to the gray level value data written in the first storage area 105A and the second storage area 105B and the first LUT 1061. Here, since the controller 106 drives the pixels by using the first LUT 1061, the rewriting of the screen shown in FIG. 10A completes in 30 frame periods. Note that the first instruction may include information about the area to be rewritten, and the controller 106 may drive the area indicated by the information included in the first instruction by the first method, instead of driving the entire screen.

Exemplary Operation for Rewriting an Area Including Only Images

For example, when the area to be rewritten includes only an image object as shown in FIG. 10B, in other words, when the area to be displayed has only the second area (indicated by the dotted line) (YES at Step SA5), the control unit 100 outputs, to the controller 106, the second instruction, which is the instruction for driving the entire screen by the second method (Step SA6). Upon acquisition of the second instruction, the controller 106 drives the display unit 107 by the second method according to the gray level value data written in the first storage area 105A and the second storage area 105B and the second LUT 1062. Here, since the controller 106 drives the pixels by using the second LUT 1062, the rewriting of the screen shown in FIG. 10B completes in 45 frame periods. Note that the second instruction may include information about the area to be rewritten, and the controller 106 may drive the area indicated by the information included in the second instruction by the second method, instead of driving the entire screen.

Exemplary Operation for Rewriting an Area Including Both Characters and Images

For example, when the area to be rewritten includes both the first area and the second area and the first area and the second area do not overlap as shown in FIG. 10C (NO at Step SA7), the control unit 100 outputs, to the controller 106, the third instruction, which is the instruction for first driving the entire screen by the first method and then driving the second area by the second method, and information indicating the second area (Step SA8). Upon acquisition of the third instruction and the information indicating the second area, the controller 106 first drives the display unit 107 by the first method according to the gray level value data written in the first storage area 105A and the second storage area 105B and the first LUT 1061. Note that information indicating the first area may be transmitted to the controller 106 as well as the information indicating the second area, and the controller 106 may first drive only the first area and the second area by the first method instead of driving the entire screen, and then drive only the second area by the second method.

Consequently, the displaying of the characters in the first area completes in 30 frame periods. On the other hand, the binarized image in the second area is displayed in 30 frame periods. In this way, by driving the first area and the second area by the first method, displaying is first completed with respect to the characters and a schematic view of the images. Since updating of the area to be displayed with two gray levels and updating of the area to be displayed with more than two gray levels are started at the same time, the user feels as if the display is updated more quickly than in the case of the method according to the related art by which the updating of the area to be displayed with two gray levels and the updating of the area to be displayed with more than two gray levels are started with different timings.

Upon completion of the driving of the display unit 107 by the first method, the controller 106 next drives the area indicated by the information received from the control unit 100 (i.e., the second area) by the second method according to the gray level value data written in the first storage area 105A and the second storage area 105B and the second LUT 1062. Consequently, the contents of the second area displayed with two gray levels are updated, and the images within the second area are displayed with 16 gray levels. Since an area including pictures, figures, etc. is displayed with a greater number of gray levels than the first area, the above-described configuration improves the display quality.

As described, the present embodiment successfully combines the effect of making the user feel as if the display is updated quickly and the effect of improving the display quality.

Exemplary Operation for Rewriting an Area in Which an Area Including Characters and an Area Including Images Overlap Each Other

For example, when the area to be rewritten includes both the first area and the second area and the first area and the second area overlap each other as shown in FIG. 10D (YES at Step SA7), the control unit 100 outputs, to the controller 106, the second instruction, which is the instruction for driving the entire screen by the second method (Step SA8). Upon acquisition of the second instruction, the controller 106 drives the display unit 107 by the second method according to the gray level value data written in the first storage area 105A and the second storage area 105B and the second LUT 1062. Here, since the controller 106 drives the pixels by using the second LUT 1062, the rewriting of the screen shown in FIG. 10D completes in 45 frame periods.

As described above, even when the area to be rewritten includes both an area to be displayed with two gray levels and an area to be displayed with 16 gray levels, the present embodiment has the effect of making the user feel as if the display is updated quickly. Furthermore, when the area to be rewritten includes only an area to be displayed with two gray levels, the screen is updated by the first method within a smaller number of frame periods than in the case of displaying with 16 gray levels, and therefore the display is updated more quickly.

Modification Examples

Although an embodiment of the invention is described above, the invention is not limited to the above-described embodiment, and may be implemented in other various modes. For example, the invention may be implemented by modifying the above-described embodiment in the manner described below. Note that the embodiment described above and the modification examples shown below may be combined with each other.

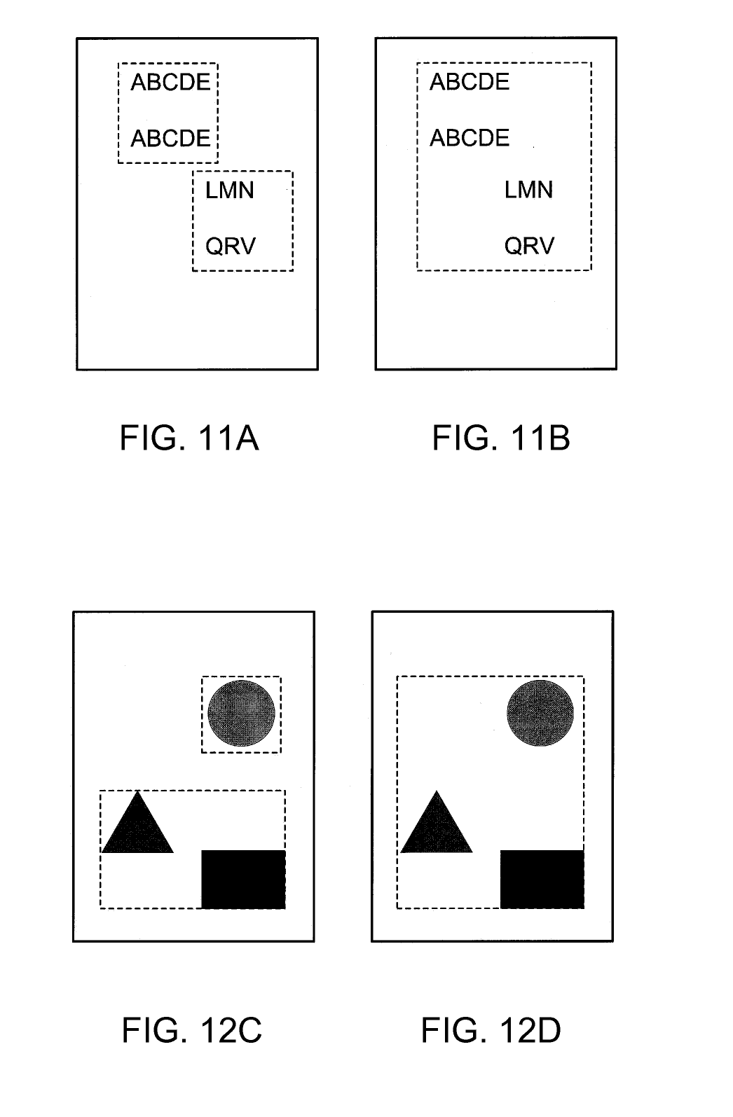

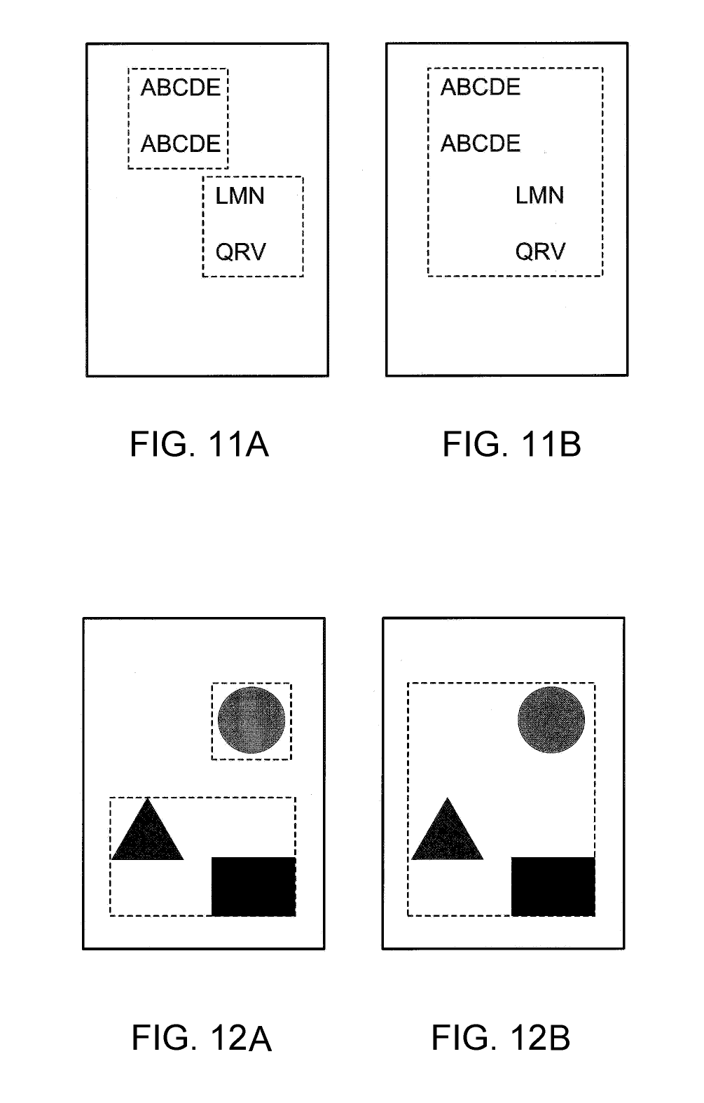

In the embodiment described above, when the first area is provided in a plurality as indicated by the dotted line in FIG. 11A, the plurality of first areas may be merged into a single rectangular first area as shown in FIG. 11B. If this is the case, when each of the vertices of each of the first areas to be merged is represented by coordinates (x, y), a rectangular area is defined with the vertex having the smallest x and the smallest y representing the starting point and the vertex having the largest x and the largest y representing the ending point. Also, in the embodiment described above, when there are a plurality of second areas as indicated by the dotted line in FIG. 12A, the plurality of second areas may be merged into a single rectangular second area as shown in FIG. 12B. Also, in the embodiment described above, when the second area is provided in a plurality and some of the plurality of second areas overlap each other, the second areas overlapping each other may be merged into a single rectangular second area.

In the embodiment described above, when the first area and the second area overlap each other as shown in FIG. 10D, the control unit 100 outputs the second instruction at Step SA8. However, the control unit 100 may output the third instruction in this case as well.

In the embodiment described above, when the second area is provided in a plurality within a same page as shown in FIG. 12A, the control unit 100, when outputting the third instruction at Step SA8, may output pieces of information respectively indicating the plurality of second areas. The controller 106 may be configured to, when the controller 106 acquires pieces of information respectively indicating the second areas and drives each second area by the second method, sequentially update the second areas in descending order of size (i.e., the number of the pixels).

The controller 106 may be configured to, when there are both the first area and the second area, drive only the area to be updated instead of updating the entire screen by the first method. For example, the controller 106 may be configured to, when displaying, within the display area, a user interface image used for operating the display apparatus 10, not update the user interface image and update only the portion of the page where the contents are to be displayed.

In the embodiment described above, the number of the gray levels after the driving by the first method is two. However, the number of the gray levels after the driving may be changed to four by modifying the contents of the LUT. Also, in the embodiment described above, the number of the gray levels after the driving by the second method is 16. However, the number of the gray levels after the driving may be changed to eight by modifying the contents of the LUT. In short, the number of the gray levels after the driving by the first method and the number of the gray levels after the driving by the second method may be different from the embodiment insofar as the number of the gray levels after the driving by the second method is larger than after the driving by the first method, and the time required for the updating by the first method is shorter than the time required for the updating by the second method.

In the embodiment described above, the format of the document files is PDF. However, the format is not limited to PDF, and may be another format.

In the embodiment described above, data written into the first storage area 105A and the second storage area 105B may be binarized data. For example, the values indicating the gray levels of the pixels are binarized at the rasterizing of the screen, and 0 is written into the pixels to be black and 15 is written into the pixels to be white.

The binarized data is written into the first storage area 105A, and, at the time of driving by the first method, if the value of the data stored in the first storage area 105A is 0, the table shown in FIG. 4A is referred to. For example, with respect to a given pixel, when the value of the data stored in the second storage area 105B is 15, and the value of the data stored in the first storage area 105A is 0, the controller 106 refers to the row corresponding to the current gray level value “15” in the table shown in FIG. 4A, and applies the positive voltage to the pixel during the period from the 1^{st} frame to the 15^{th} frame, and discharges the pixel during the period from the 16^{th} frame to the 30^{th} frame. When the value of the data stored in the second storage area 105B is any of 1 to 14, the controller 106 may discharge the pixel during the period from the 1^{st} frame to the 30^{th} frame so that the gray level will not be changed.

On the other hand, when the binarized data is written into the first storage area 105A, and, at the time of driving by the first method, if the value of the data stored in the first storage area 105A is 15, the table shown in FIG. 4B is referred to. For example, with respect to a given pixel, when the value of the data stored in the second storage area 105B is 0, and the value of the data stored in the first storage area 105A is 15, the controller 106 refers to the row corresponding to the current gray level value “0” in the table shown in FIG. 4B, and discharges the pixel during the period from the 1^{st} frame to the 15^{th} frame, and applies the negative voltage to the pixel during the period from the 16^{th} frame to the 30^{th} frame. When the value of the data stored in the second storage area 105B is any of 1 to 14, the controller 106 may discharge the pixel during the period from the 1st frame to the 30th frame so that the gray level will not be changed.

The embodiment described above has a unipolar driving structure, in which either the first voltage or the second voltage is applied during a single frame period. However, a bipolar driving structure may be adopted, in which both the first voltage and the second voltage can be applied during a single frame period.

Programs that are executed by the display apparatus 10 may be installed from a state of being stored on a computer-readable recording medium such as a magnetic recording medium (magnetic tape, magnetic disk (HDD (Hard Disk Drive), FD (Flexible Disk)), etc.), an optical recording medium (optical disc etc.), a magneto-optical recording medium, or a semiconductor memory. The programs may also be installed by being downloaded via a communication line.

This application claims priority from Japanese Patent Application No. 2014-095030 filed in the Japanese Patent Office on May 2, 2014 the entire disclosure of which is hereby incorporated by reference in its entirely.

What is claimed is:

1. A display apparatus comprising:
an updating unit that updates a first area by a first method, and updates a second area by a second method, the first area being at least a portion of a display area of a display unit, and the second area being a portion of the display area,
wherein the number of gray levels that can be expressed by the first method is N, where N denotes an integer no less than 2 and less than M,
the number of gray levels that can be expressed by the second method is M, where M denotes an integer no less than 3, and
the speed of the updating by the first method is greater than the speed of the updating by the second method.

2. The display apparatus according to claim 1,
wherein the second area is an area including an image object,
a file corresponding to a screen that is to be displayed on the display area includes information indicating the second area, and
the updating unit specifies the second area based on the information.

3. The display apparatus according to claim 2,
wherein the updating unit updates a third area by the second method at the same time as updating at least a portion of the second area, the third area including an image object.

4. The display apparatus according to claim 2,
wherein, before or after updating the second area by the second method, the updating unit updates a third area by the second method, the third area including an image object.

5. The display apparatus according to claim 4,
wherein the updating unit sequentially updates a plurality of second areas and the third area in descending order of size.

6. The display apparatus according to claim 2,
wherein, when at least a portion of the second area overlaps at least a portion of a third area, the updating unit merges the second area and the third area into a single area and updates the single area by the second method, the third area including an image object.

7. A display method comprising:
updating a first area by a first method, and updating a second area by a second method, the first area being at least a portion of a display area of a display unit, and the second area being a portion of the display area,
wherein the number of gray levels that can be expressed by the first method is N, where N denotes an integer no less than 2 and less than M,
the number of gray levels that can be expressed by the second method is M, where M denotes an integer no less than 3, and
the speed of the updating by the first method is greater than the speed of the updating by the second method.

8. A display method for the use by a display apparatus with a display area having memory, comprising:
updating a first area according to a first waveform during 1^{st} to m^{th} frame periods, the first area including an image object, and the first waveform being a waveform according to which a first number of gray levels can be expressed; and
updating a second area according to a second waveform during 1^{st} to n^{th} frame periods, where n is less than m, the second area including no image object, and the second waveform being a waveform according to which a second number of gray levels can be expressed, the second number being smaller than the first number.
